(19) United States
(12) Patent Application Publication
(10) Pub. No.: US 2026/0155851 A1
(43) Pub. Date: Jun. 4, 2026

(54) AI-BASED DIGITAL PRE-DISTORTION FOR DIGITAL ENVELOPE TRACKING POWER AMPLIFIERS

(71) Applicant: Samsung Electronics Co., Ltd., Suwon-si (KR)

(72) Inventors: Fahid Hassan, Houston, TX (US); Matthew Tonnemacher, Allen, TX (US); Chance Anthony Tarver, Arlington, TX (US); Masoud Shahshahani, Allen, TX (US); Gang Xu, Allen, TX (US)

(21) Appl. No.: 19/253,699

(22) Filed: Jun. 27, 2025

Related U.S. Application Data
(60) Provisional application No. 63/727,918, filed on Dec. 4, 2024.

(51) Int. Cl. H04B 1/04

(52) U.S. Cl. CPC H04B 1/0475; H04B 2001/0425; H04B 2001/045

(57) ABSTRACT

Methods and systems for AI-based digital pre-distortion for digital envelope tracking power amplifiers. A method includes receiving a measurement of a digital envelope at a digital predistortion module having a neural network (NN)-based digital predistortion structure for a digital envelope tracking (DET) system, receiving a transmit signal at the digital predistortion module, inputting the measurement of the digital envelope and the transmit signal into a generalized memory polynomial (GMP) model of the AI-based digital predistortion structure to produce a pre-distorted transmit signal, processing the pre-distorted transmit signal using an AI model of the AI-based digital predistortion structure to produce an adjusted pre-distorted transmit signal to correct one or more non-linearities in a power amplifier operable coupled to the digital predistortion module, and generating an output signal using the power amplifier based on the adjusted pre-distorted transmit signal.

### CROSS-REFERENCE TO RELATED APPLICATIONS AND CLAIM OF PRIORITY

The present application claims priority to U.S. Provisional Patent Application No. 63/727,918, filed on Dec. 4, 2024, which is hereby incorporated by reference in its entirety.

### TECHNICAL FIELD

The present disclosure relates generally to wireless communication systems. More specifically, the present disclosure relates to a system and method for AI-based digital pre-distortion for digital envelope tracking power amplifiers.

### BACKGROUND

In 6G extreme-MIMO systems, there are likely to be hundreds of power amplifiers in a single base station. These power amplifiers typically consume the majority of the power budget of the base station. Moreover, their power-added efficiency (PAE), the main performance metric of a power amplifier, is often as low as 20%. The lower PAE is indicative of wasted power that contributes significantly to thermal concerns and increases the operational expenditure costs of a system. Additionally, there is a nonlinear relationship between input and output power; as the input power increases, a fixed gain is not perfectly maintained. Digital pre-distortion (DPD) may compensate for PA nonlinearity, but conventional DPD assumes that the PA nonlinearity is not dynamic and is not powerful enough to accommodate and address the challenges in PA linearization.

Accordingly, there is a need for systems and methods for improved digital pre-distortion for digital envelope tracking systems that overcome these challenges.

### SUMMARY

The present disclosure relates generally to wireless communication systems and, more specifically, the present disclosure relates to a system and method for AI-based digital pre-distortion for digital envelope tracking power amplifiers.

In one embodiment, a method is provided. The method includes receiving a measurement of a digital envelope at a digital predistortion module having a neural network (NN)-based digital predistortion structure for a digital envelope tracking (DET) system, receiving a transmit signal at the digital predistortion module, inputting the measurement of the digital envelope and the transmit signal into a generalized memory polynomial (GMP) model of the AI-based digital predistortion structure to produce a pre-distorted transmit signal, processing the pre-distorted transmit signal using an AI model of the AI-based digital predistortion structure to produce an adjusted pre-distorted transmit signal to correct one or more non-linearities in a power amplifier operable coupled to the digital predistortion module, and generating an output signal using the power amplifier based on the adjusted pre-distorted transmit signal.

In another embodiment, an electronic device is provided. The electronic device includes a power amplifier, and a processor operably coupled to the power amplifier. The processor is configured to cause the electronic device to receive a measurement of a digital envelope at a digital predistortion module having a neural network (NN)-based digital predistortion structure for a digital envelope tracking (DET) system, receive a transmit signal at the digital predistortion module, input the measurement of the digital envelope and the transmit signal into a generalized memory polynomial (GMP) model of the AI-based digital predistortion structure to produce a pre-distorted transmit signal, process the pre-distorted transmit signal using an AI model of the AI-based digital predistortion structure to produce an adjusted pre-distorted transmit signal to correct one or more non-linearities in the power amplifier operable coupled to the digital predistortion module, and generate an output signal using the power amplifier based on the adjusted pre-distorted transmit signal.

In yet another embodiment, a non-transitory computer-readable medium is provided. The non-transitory computer-readable medium includes program code, that when executed by at least one processor of an electronic device, causes the electronic device to receive a measurement of a digital envelope at a digital predistortion module having a neural network (NN)-based digital predistortion structure for a digital envelope tracking (DET) system, receive a transmit signal at the digital predistortion module, input the measurement of the digital envelope and the transmit signal into a generalized memory polynomial (GMP) model of the AI-based digital predistortion structure to produce a pre-distorted transmit signal, process the pre-distorted transmit signal using an AI model of the AI-based digital predistortion structure to produce an adjusted pre-distorted transmit signal to correct one or more non-linearities in a power amplifier operable coupled to the digital predistortion module, and generate an output signal using the power amplifier based on the adjusted pre-distorted transmit signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4 illustrates an example signal envelope of a power amplifier;

FIG. 5 illustrates an example method for applying AI-based digital pre-distortion to a DET system according to embodiments of the present disclosure;

FIGS. 6A-6B illustrate example artificial intelligence (AI)-assisted digital pre-distortion (DPD) structures according to embodiments of the present disclosure;

FIG. 7 illustrates an example method for applying AI-based digital pre-distortion to a DET system according to embodiments of the present disclosure;

FIGS. 8A-8B illustrate example artificial intelligence (AI)-assisted digital pre-distortion (DPD) structures according to embodiments of the present disclosure; and

FIG. 9 illustrates an example method of AI-assisted digital pre-distortion for digital envelope tracking power amplifiers according to embodiments of the present disclosure.

### DETAILED DESCRIPTION

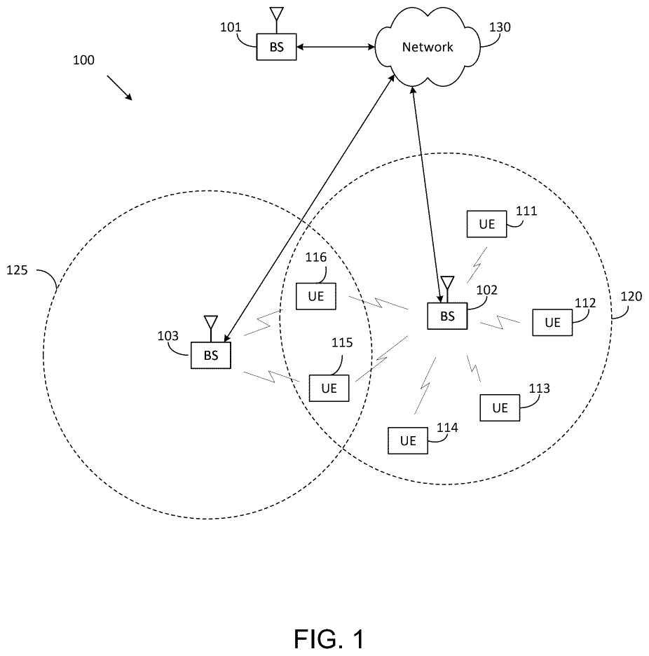

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, power amplifiers typically consume the majority of the power budget of the base station. While it is convenient to model power amplifiers as having a fixed gain, there is a nonlinear relationship between input and output power. As the input power increases, a fixed gain is not perfectly maintained. Digital pre-distortion (DPD) may be used to compensate for power amplifier nonlinearity by applying a correction to the signal before transmission to account for the nonlinear behavior of a power amplifier.

Additionally, digital envelope tracking (DET) may produce more power-efficient devices by reducing the power consumption of power amplifiers. The reduction in power consumption is accomplished by dynamically modifying the supply voltages amongst multiple discrete voltage levels based on the real-time signal envelope. The lower the amplitude of transmission RF signal is, the lower the power amplifier supply voltage is applied, thus leading lower average operating power of the power amplifier.

However, DET technology can introduce additional challenges to power amplifier linearization due to the time-varying power amplifier characteristics when modifying power amplifier supply voltages dynamically. More specifically, some generalized memory polynomial (GMP) models used for DPD with fixed supply voltage are not flexible enough to manage the time-varying power amplifier characteristics.

Accordingly, the present disclosure provides systems and methods for AI-based digital pre-distortion for digital envelope tracking power amplifiers. As described herein, the present disclosure includes an AI/neural network (NN)-based digital pre-distortion structure that inputs a measure of the digital envelope as a feature to address the challenges in power amplifier nonlinearity compensation when considering DET. In particular, the present disclosure provides AI-based DPD designs where the supply voltage levels are considered as AI inputs along with signal in-phase and quadrature (I/Q) components, such that the AI model is able to determine dynamic nonlinearity when applying different supply voltage levels.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipment (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

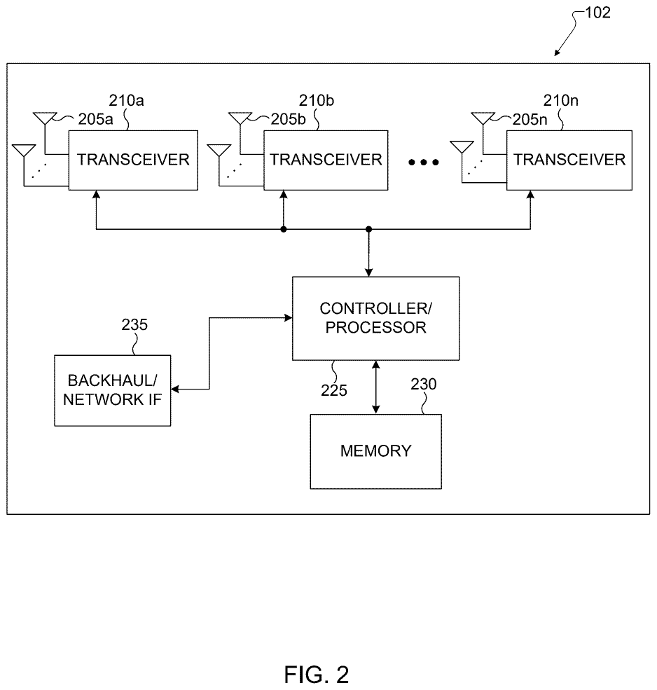

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The network interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the network interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

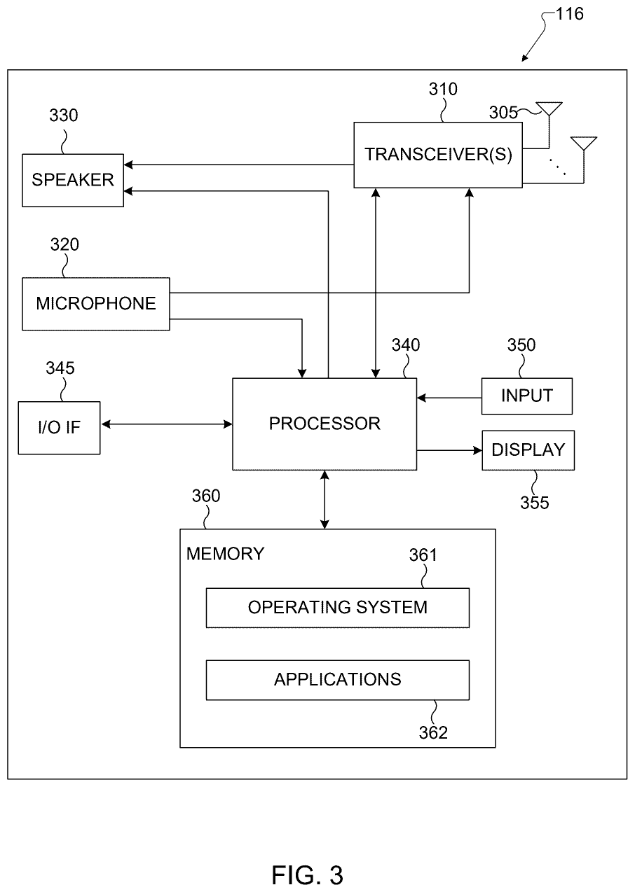

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

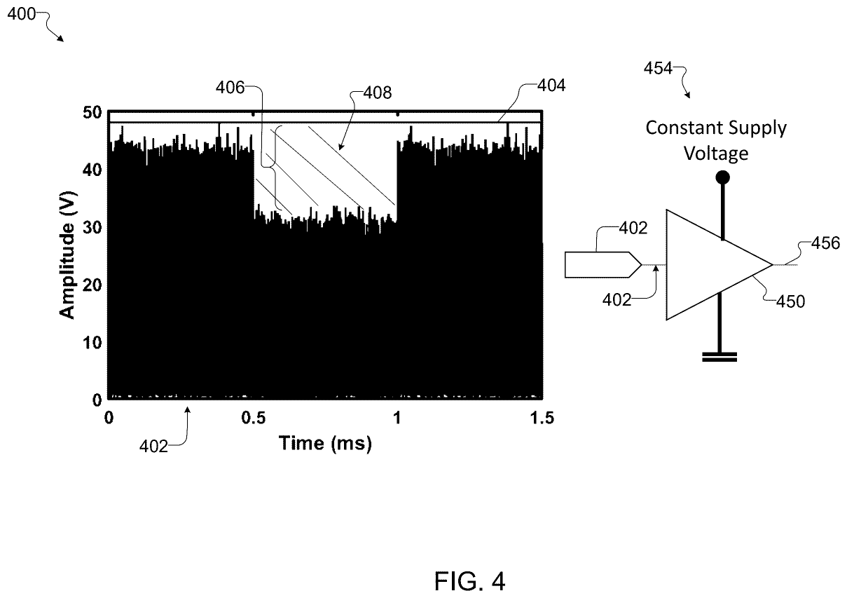

The TX processing circuitry of the gNB 101 may also include one or more power amplifiers coupled to one or more digital-to-analog converters and configured to amplify the baseband signal prior to transmission using the antenna. The one or more power amplifiers receive a supply voltage sufficient to cover the signal envelope of the baseband signal, as shown in FIG. 4.

FIG. 4 illustrates an example signal envelope 400 of a power amplifier 450. As shown in FIG. 4, the signal envelope 400, which may be represented as amplitude voltage over time, includes a RF envelope 402 representative of a baseband signal supplied to the power amplifier 450 from the DAC 452. In response to receiving the RF envelope 402, the power amplifier 450, using a constant supply voltage source 454 provides a PA supply voltage 404 to generate an output signal 456. The PA supply voltage 404 may need to have a voltage level (e.g., 48 volts as shown) greater than the RF envelope 402 to be effective. The RF envelope 402, however, fluctuates over time, creating a gap 406 between the RF envelope 402 and the PA supply voltage 404. The gap 406 creates an area of wasted energy 408 as the PA supply voltage 404 remains constant despite the RF envelope 402 changing voltage levels over time.

Further, the gap 406 forces the power amplifier 450 to operate in a power backoff mode. In a power backoff mode, the power amplifier 450 operates at a reduced power level below its maximum output, especially when dealing with signals that have large peaks in power, ensuring the power amplifier 450 stays within its linear operating region even during high signal bursts from the DAC 452. While operating in backoff mode can improve signal quality, it usually comes at the cost of reduced power efficiency as the power amplifier 450 is not operating at its peak power output. In particular, when the power amplifier 450 operates in a power backoff mode, its power added efficiency (PAE) typically decreases significantly, reducing the effectiveness of the power amplifier 450 in amplifying the RF envelope 402.

Although FIG. 4 illustrates one example of a signal envelope of a power amplifier, various changes may be made to FIG. 4. For example, the baseband signal may fluctuate between more than two voltage levels, such as between three or more voltage levels, such as between 4 or more voltage levels.

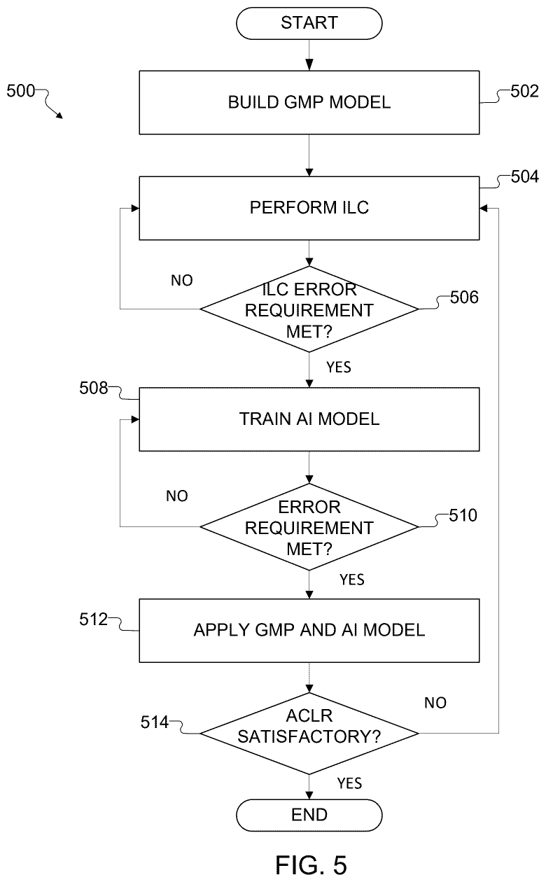

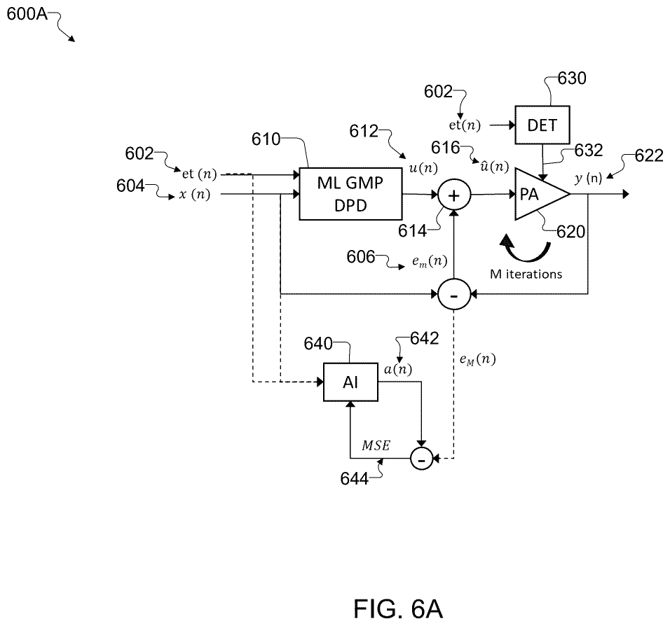

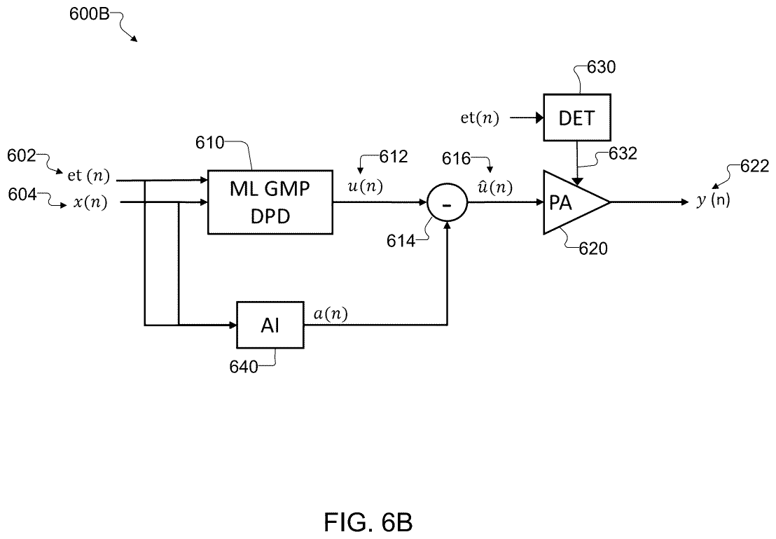

To improve power efficiency, the area of wasted energy 408 should be minimized between the RF envelope 402 and the PA supply voltage 404. This may be accomplished by addressing the challenges in PA nonlinearity compensation when using DET, for example, by providing a pre-distorted RF signal to the PA using an AI-assisted digital pre-distortion architecture as shown in FIGS. 5 and 6A-6B.

FIG. 5 illustrates an example method 500 for applying AI-based digital pre-distortion to a DET system according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of digital pre-distortion could be used without departing from the scope of this disclosure.

FIGS. 6A-6B illustrates an example artificial intelligence (AI)-assisted digital pre-distortion (DPD) structure according to embodiments of the present disclosure. In particular, FIG. 6A illustrates an example AI-assisted DPD training structure 600A and FIG. 6B illustrates an example AI-assisted DPD operating structure 600B. The embodiments of the AI-assisted DPD training structure 600A and the AI-assisted DPD operating structure 600B shown in FIGS. 6A-6B are for illustration only. Other embodiments of the AI-assisted DPD training structure 600A and the AI-assisted DPD operating structure 600B could be used without departing from the scope of this disclosure.

As shown in FIG. 6A, the AI-assisted DPD training structure 600A includes a discrete transmit signal 602 and an envelope tracking signal 604 that may be input into a GMP function 610. The GMP function 610 generates a pre-distorted transmit signal 612 that may be input into a combiner function 614. The combiner function 614 receives a residual nonlinearity 606 and combines the residual nonlinearity 606 with the pre-distorted transmit signal 612 to generate an ideal pre-distorted transmit signal 616. The ideal pre-distorted transmit signal 616 is provided to a power amplifier (PA) 620. The PA 620 also receives a DET signal 632 from a DET module 630, which generated the DET signal 632 using the discrete transmit signal 602. The PA 620 uses the ideal pre-distorted transmit signal 616 and the DET signal 632 to generate an output signal 622. The AI-assisted DPD training structure 600A also includes an AI model 640 that receives the discrete transmit signal 602 and the envelope tracking signal 604 to generate an AI output signal 642. The AI output signal 642 is combined with the residual nonlinearity 606 to generate a mean square error (MSE) 644 that is fed back into the AI model 640 for training purposes.

Next, the AI starts training until a desired error level is met, which can be specified as a design choice. Finally, the AI-Assisted DPD is applied and evaluated.

A GMP model is built at step 502. For example, a GMP function 610 may be built using a series of polynomials, such as a time-aligned memory polynomial, a lagging cross-terms polynomial, and a leading cross-terms polynomial. The time-aligned memory polynomial may be defined by a non-linearity order and a memory depth that is applied to an input signal (such as a discrete transmit signal 602 and an envelope tracking signal 604). The lagging cross-terms polynomial introduces interactions between the input and is defined by the input signal and lagging envelope terms to help capture past signal dependencies. The leading cross-terms polynomial introduces interactions between the input signal and leading envelope terms to help capture future signal dependencies. Each polynomial may have its respective coefficients to determine the weight of each polynomial in the GMP function 610. The GMP function 610 subsequently produces a pre-distorted transmit signal 612 which is a data vector that combines all polynomial functions.

Additionally, or alternatively, in DET systems with multiple supply voltage levels, the GMP model may include multiple GMP sub-models where each of the GMP sub-models are based on one of multiple supply voltage levels of the DET system. In such configurations, each GMP sub-model includes its own series of polynomials and polynomial coefficients configured to linearize input voltages within a predetermined voltage range corresponding to an assigned DET supply voltage. Using multiple GMP sub-models allows for nonlinearity to be addressed at each DET supply voltage level individually, increasing efficiency across all DET voltage levels.

An indirect learning control (ILC) process is performed to calculate a residual error (or nonlinearity) of the GMP model at step 504. For example, the ILC may include a first iteration m, where the residual nonlinearity 606 eₘ(n) is calculated as the difference between the output signal 622 y(n) and the envelope tracking signal 604 x(n). In the next iteration, the residual nonlinearity 606 is added to the pre-distorted transmit signal 612 and the sum is injected into the PA 620. In each iteration, the GMP function 610 is trained as an inverse of the PA 620 to compensate the nonlinearity based on the measured data, i.e., by using the output signal 622 I/Q components and the corresponding supply voltage levels as AI inputs, and the output signal 622 I/Q components as labels of AI outputs. The trained AI-DPD model coefficients including AI weights and biases are updated in the GMP function 610.

The ILC is performed until an ILC error requirement (or objective) is met (step 506). For example, the ILC process will repeat iteratively until the ideal pre-distorted transmit signal 616 is below a predetermined threshold, such as a desired linearity of the ideal pre-distorted transmit signal 616. After M iterations, the final error 608 e_{M}(n) is used as the labeled output for training.

The AI model is then trained at step 508. For example, the AI may use the envelope tracking signal 604 (I/Q components) and the corresponding discrete transmit signal 602 as AI inputs and the final error 608 as the labeled data. The AI model 640 may include a neural network, such as a convolutional neural network, with model weights or coefficients. The number of training epochs per cycle is chosen to be long enough to allow the AI model coefficients to converge. The AI model 640 may be further configured, in DET systems with multiple supply voltage levels, to linearize residual non-linearities caused by inter-level transitions between the multiple supply voltage levels. The AI model 640 is trained until an error requirement is met (step 510). The error requirement is related to the non-linear effect of the PA 620, such as the adjacent channel leakage ratio (ACLR).

The GMP and the AI model are applied in step 512. For example, the GMP function 610 and the AI model 640 may be applied in operating conditions outside of a training environment using the AI-assisted DPD operating structure 600B as shown in FIG. 6B. The AI-assisted DPD operating structure 600B is configured similarly to the AI-assisted DPD training structure 600A except as otherwise described. The AI-assisted DPD operating structure 600B omits calculation of the residual nonlinearity 606 or the final error 608 and instead the pre-distorted transmit signal 612 and the AI output signal 642 are summed to produce the ideal pre-distorted transmit signal 616, which is subsequently used by the PA 620 to produce the output signal 622.

The GMP model and the AI model are applied until, for example, the PA output achieves satisfactory adjacent channel leakage ratio (ACLR) (step 514) based on predetermined thresholds or values. For example, if the AI-assisted DPD operating structure 600B determines that the performance metrics are not within the predetermined threshold, the AI-assisted DPD operating structure 600B may indicate required training or transition back to the AI-assisted DPD training structure 600A to repeat steps 504-510.

As shown in FIG. 5, multiple cycles of training may be required until the output signal 622 achieves desired adjacent channel leakage ratio (ACLR) or other measure of performance, at the output of the power amplifier.

Although FIG. 5 illustrates an example method 500 for applying AI-based digital pre-distortion to a DET system, various changes may be made to FIG. 5. For example, while shown as a series of steps, various steps in FIG. 5 could overlap, occur in parallel, occur in a different order, or occur any number of times. For example, the AI-assisted DPD training structure 600A may not use ILC in the training procedure, but instead the AI coefficients are trained on the PA output error directly for each iteration. In embodiments where a different signal processing algorithm is used besides a GMP for the initial DPD component, the AI-assist DPD module can still be used in series or added to the output.

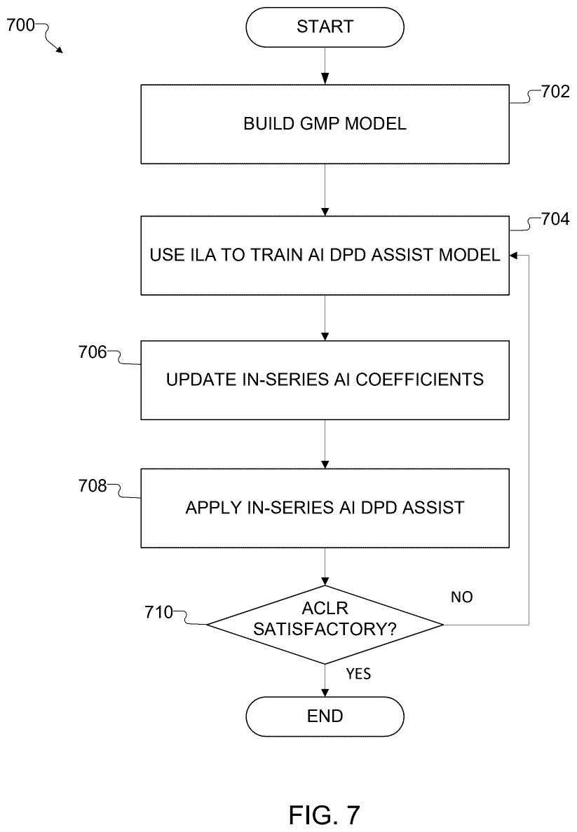

Although FIGS. 6A and 6B illustrate an example AI-based digital pre-distortion architecture, various changes may be made to FIGS. 6A and 6B. For example, the GMP model may be cascaded with an AI-assisted DPD model to generate a pre-distorted transmit signal, as shown in FIG. 7.

FIG. 7 illustrates an example method 700 for applying AI-based digital pre-distortion to a DET system according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of digital pre-distortion could be used without departing from the scope of this disclosure.

As shown in FIG. 7, multiple cycles of AI training may be required until the PA output achieves desired ACLR performance. The AI-DPD testing and performance evaluation is performed by fixing the trained AI-DPD model and measuring its performance at the output of the PA.

In the training cycles, the AI-DPD assist coefficients are updated iteratively. In each iteration, the AI-assisted DPD model is trained as an inverse of the power amplifier and GMP model to compensate for residual nonlinearity based on measured data. As such, the PA output I/Q components are used as inputs to the GMP-to-AI chain, and the PA input I/Q components are used as labels of AI outputs. The trained AI-assisted DPD model coefficients, including weights and biases, are updated in both the AI training model and the AI-assisted DPD model.

In this embodiment, the AI DPD assist model is placed in series with the GMP model. Instead of learning the ideal signal to cancel out the residual error from the GMP, this embodiment uses an indirect learning architecture (ILA) to learn a cascaded predistortion on top of the GMP-based predistortion signal.

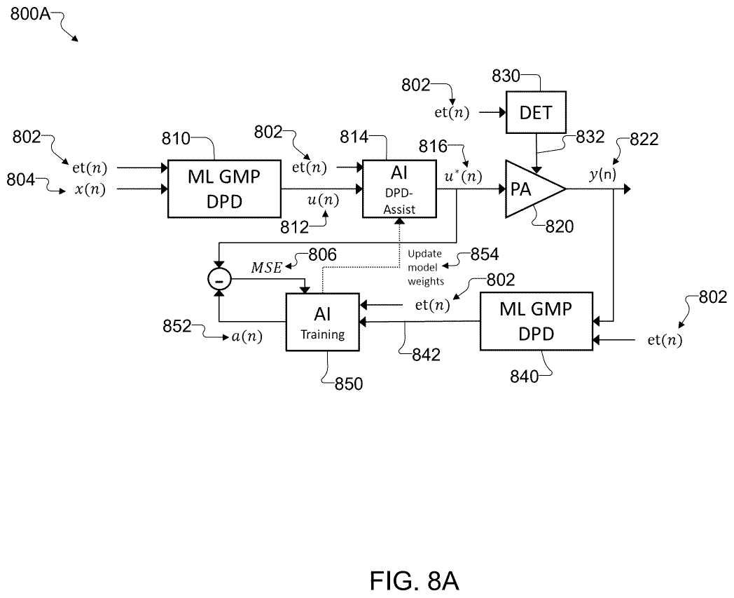

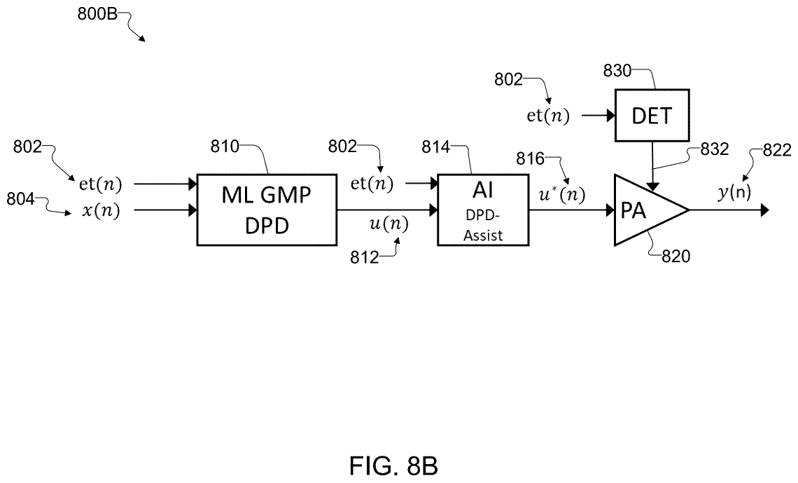

FIGS. 8A-8B illustrate example artificial intelligence (AI)-assisted digital pre-distortion (DPD) structures according to embodiments of the present disclosure. In particular, FIG. 8A illustrates an example AI-assisted DPD training structure 800A and FIG. 8B illustrates an example AI-assisted DPD operating structure 800B. The embodiments of the AI-assisted DPD training structure 800A and the AI-assisted DPD operating structure 800B shown in FIGS. 8A-8B are for illustration only. Other embodiments of the AI-assisted DPD training structure 800A and the AI-assisted DPD operating structure 800B could be used without departing from the scope of this disclosure.

As shown in FIG. 8A, the AI-assisted DPD training structure 800A includes a discrete transmit signal 802 and an envelope tracking signal 804 that are input into a first GMP function 810 that generates a pre-distorted transmit signal 812. The pre-distorted transmit signal 812, along with the discrete transmit signal 802, is input into an AI-assisted DPD function 814 to generate a cascaded pre-distorted transmit signal 816. The cascaded pre-distorted transmit signal 816 is provided to a power amplifier (PA) 820 along with an DET signal 832 from a DET module 830. The PA 820 then uses the cascaded pre-distorted transmit signal 816 and the DET signal 832 to generate an output signal 822. The output signal 822 may be fed into a second GMP model 840, configured for nonlinearization training of an AI training model 850, along with the discrete transmit signal 802 to generate a GMP training output 842. The GMP training output 842 and the discrete transmit signal 802 are then provided to the AI training model 850 for training. The AI training model 850 generates an AI output signal 852 that is combined with the cascaded pre-distorted transmit signal 816 (such as through subtraction) to generate an MSE 806 that is fed back into the AI training model 850 for adjustment. The AI training model 850 also provides in-series AI coefficients 854 to the AI-assisted DPD function 814 to tune the cascaded pre-distorted transmit signal 816 (such as to reduce non-linearity of the cascaded pre-distorted transmit signal 816).

Referring to FIG. 7, a GMP model is built in step 702. For example, a first GMP function 810 may be built using a series of polynomials, such as a time-aligned memory polynomial, a lagging cross-terms polynomial, and a leading cross-terms polynomial. The time-aligned memory polynomial may be defined by a non-linearity order and a memory depth that is applied to an input signal (such as a discrete transmit signal 802 and an envelope tracking signal 804). The lagging cross-terms polynomial introduces interactions between the input and is defined by the input signal and lagging envelope terms to help capture past signal dependencies. The leading cross-terms polynomial introduces interactions between the input signal and leading envelope terms to help capture future signal dependencies. Each polynomial may have its respective coefficients to determine the weight of each polynomial in the first GMP function 810. The first GMP function 810 subsequently produces a pre-distorted transmit signal 812 which is a data vector that combines all polynomial functions.

The AI DPD assist model is trained using an indirect learning architecture (ILA) in step 704. For example, the AI-assisted DPD function 814 may be trained in the ILA as an inverse of the power amplifier to compensate the non-linearity based on measured data. The measured data (such as the cascaded pre-distorted transmit signal 816 u^{¿}(n), the output signal 822 y(n), and the discrete transmit signal 802 et(n)) are updated accordingly, and are used to retrain the AI training model 850 the next iteration. The number of training epochs per cycle should be chosen long enough such that the model coefficients completely converge.

The in-series AI coefficients are updated upon completion of ILA training (step 706). For example, the in-series AI coefficients may be updated upon convergence. Once converged, the AI-assisted DPD function 814 can be used directly in series with the first GMP function 810 (FIG. 8B) for an enhanced predistortion for DET-enabled power amplifiers.

As shown in FIG. 8B, the AI-DPD assistance is applied to a power amplifier in step 708. For example, after obtaining final values of the in-series AI coefficients 854, the first GMP function 810 and the AI-assisted DPD function 814 are applied during real-time operation of the AI-assisted DPD operating structure 800B to update the measured data, such as the pre-distorted transmit signal 808, the output signal 822, and the discrete transmit signal 802.

The AI-assisted DPD operating structure 800B will determine if performance metrics are within predetermined threshold in step 710. For example, the AI-assisted DPD function 814 is applied until performance metrics (e.g., power efficiency, ACLR, EVM) are satisfactory or within a predetermined threshold. If the AI-assisted DPD operating structure 800B determines that the performance metrics are not within the predetermined threshold, the in-series AI coefficients 854 may be updated (such as by repeating steps 704-706).

Although FIG. 7 illustrates an example method 700 for applying AI-based digital pre-distortion to a DET system, various changes may be made to FIG. 7. For example, while shown as a series of steps, various steps in FIG. 7 could overlap, occur in parallel, occur in a different order, or occur any number of times. For example, the AI-based DPD structure 800 may continuously repeat steps 704 through 710. As a further alternative, ILA may be replaced by an autoencoder framework is used for training in which a forward model of the PA is learned first and is used for backpropagation. This allows the AI-assisted DPD model to be directly trained after learning the forward model of the PA within a certain degree of error. In embodiments where a different signal processing algorithm is used besides a GMP for the initial DPD component, the AI-assisted DPD model may still be used in series or added to the output.

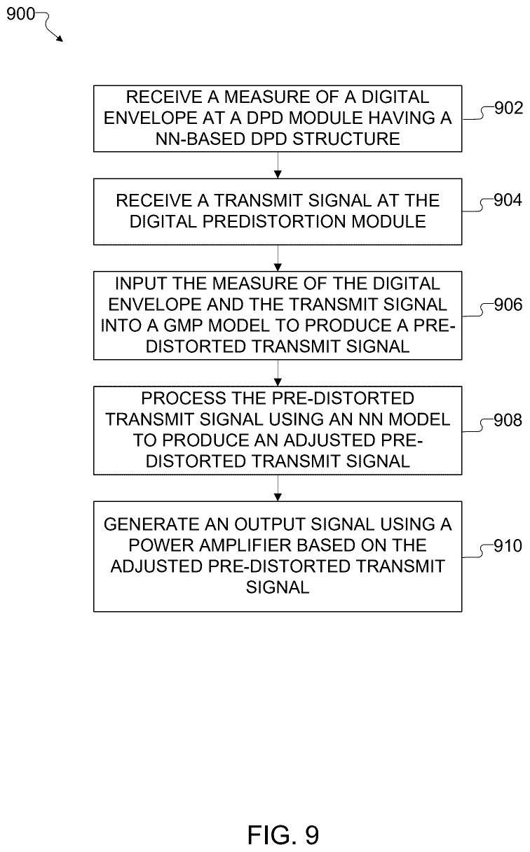

FIG. 9 illustrates an example method of AI-assisted digital pre-distortion for digital envelope tracking power amplifiers according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of digital pre-distortion could be used without departing from the scope of this disclosure. For ease of explanation, the method 900 is described using the AI-assisted DPD operating structure 600B of FIG. 6A, however, the method 900 may be used by any suitable system or any suitable DPD structure, such as the AI-assisted DPD operating structure 800B of FIG. 8B.

The digital pre-distortion module receives a measure of a digital envelope in step 902. For example, the AI-assisted DPD operating structure 600B may receive the measure of the digital envelope as the envelope tracking signal 604, e.g., from one or more baseband signals, using one or more transceivers 210 of the gNB 102.

The digital pre-distortion module also receives a transmit signal at the digital pre-distortion module in step 904. For example, the AI-assisted DPD operating structure 600B may receive the discrete transmit signal 602, e.g., from one or more baseband signals, using one or more transceivers 210 of the gNB 102. The AI-assisted DPD operating structure 600B may receive the discrete transmit signal 602 and the envelope tracking signal 604 concurrently or consecutively.

The measurement of the digital envelope and the transmit signal are input into a generalized memory polynomial (GMP) model of the AI-assisted digital predistortion structure to produce a pre-distorted transmit signal in step 906. For example, the GMP function 610 may receive the discrete transmit signal 602 and the envelope tracking signal 604 as input. The GMP function 610 is configured to linearize one or more intra-level non-linearities. For example, the GMP function 610 may include a series of polynomials that use the discrete transmit signal 602 and the envelope tracking signal 604 to generate a data vector in the form of the pre-distorted transmit signal 612. Further, in DET systems with multiple supply voltage levels, the GMP model may include multiple GMP sub-models where each of the GMP sub-models are based on one of multiple supply voltage levels of the DET system.

The pre-distorted transmit signal is processed using an AI model of the AI-based digital predistortion structure to produce an adjusted pre-distorted transmit signal to correct one or more non-linearities in the power amplifier operable coupled to the digital predistortion module in step 908. For example, the pre-distorted transmit signal 612 may be combined with the MSE 644 of the AI model 640 to generate the ideal pre-distorted transmit signal 616.

Processing the pre-distorted transmit signal using the AI model may include inputting the discrete transmit signal 602 and the envelope tracking signal 604 into the AI model 640 to produce an AI output signal 642 corresponding to a residual error estimate signal and adjusting the pre-distorted transmit signal 612 using the residual error estimate signal. Adjusting the pre-distorted transmit signal 612 using the AI output signal 642 may include subtracting the AI output signal 642 from the pre-distorted transmit signal 612. The AI model 640 may be further configured, in DET systems with multiple supply voltage levels, to linearize residual non-linearities caused by inter-level transitions between the multiple supply voltage levels.

Alternatively, processing the pre-distorted transmit signal using the AI model includes inputting the pre-distorted transmit signal and the measurement of the digital envelope into the AI model to generate an adjusted pre-distorted transmit signal such as in the AI-assisted DPD operating structure 800B. For example, the pre-distorted transmit signal 812 may be input into the AI-assisted DPD function 814 directly, along with the discrete transmit signal 802, to generate the cascaded pre-distorted transmit signal 816.

An output signal is generated using the power amplifier based on the adjusted pre-distorted transmit signal in step 910. For example, the ideal pre-distorted transmit signal 616 is provided to the PA 620. The power amplifier PA 620 uses the ideal pre-distorted transmit signal 616 and the DET signal 632 to generate an output signal 622. Alternatively, the AI-assisted DPD function 814 may provide the cascaded pre-distorted transmit signal 816 to the PA 820 which subsequently generates the output signal 822.

Although FIG. 9 illustrates one example AI-based digital pre-distortion method 900, various changes may be made to FIG. 9. For example, while shown as a series of steps, various steps in FIG. 9 could overlap, occur in parallel, occur in a different order, or occur any number of times.

The present disclosure provides for an AI-based digital pre-distortion structure that inputs a measure of a digital envelope as a feature to improve power amplifier nonlinearity compensation for digital envelop tracking.

The above flowcharts illustrate example methods that may be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
receiving a measurement of a digital envelope at a digital predistortion module having an artificial intelligence (AI)-based digital predistortion structure for a digital envelope tracking (DET) system;
receiving a transmit signal at the digital predistortion module;
inputting the measurement of the digital envelope and the transmit signal into a generalized memory polynomial (GMP) model of the AI-based digital predistortion structure to produce a pre-distorted transmit signal;
processing the pre-distorted transmit signal using an AI model of the AI-based digital predistortion structure to produce an adjusted pre-distorted transmit signal to correct one or more non-linearities in a power amplifier operable coupled to the digital predistortion module; and
generating an output signal using the power amplifier based on the adjusted pre-distorted transmit signal.

2. The method of claim 1, wherein the GMP model is configured to linearize one or more intra-level non-linearities.

3. The method of claim 1, wherein the GMP model comprises multiple GMP sub-models, wherein each of the GMP sub-models are based on one of multiple supply voltage levels of the DET system.

4. The method of claim 3, wherein processing the pre-distorted transmit signal using the AI model comprises:
inputting the measure of the digital envelope and the transmit signal into the AI model to produce a residual error estimate signal; and
adjusting the pre-distorted transmit signal using the residual error estimate signal.

5. The method of claim 4, wherein the AI model is configured to linearize residual non-linearities caused by inter-level transitions between the multiple supply voltage levels.

6. The method of claim 4, wherein adjusting the pre-distorted transmit signal using the residual error estimate signal comprises:
subtracting the residual error estimate signal from the pre-distorted transmit signal.

7. The method of claim 1, wherein processing the pre-distorted transmit signal using the AI model comprises:
inputting the pre-distorted transmit signal and the measurement of the digital envelope into the AI model to generate an adjusted pre-distorted transmit signal.

8. An electronic device, comprising:
a power amplifier; and
a processor operably coupled to the power amplifier and configured to cause the electronic device to:
receive a measurement of a digital envelope at a digital predistortion module having an artificial intelligence (AI)-based digital predistortion structure for a digital envelope tracking (DET) system;
receive a transmit signal at the digital predistortion module;
input the measurement of the digital envelope and the transmit signal into a generalized memory polynomial (GMP) model of the AI-based digital predistortion structure to produce a pre-distorted transmit signal;
process the pre-distorted transmit signal using an AI model of the AI-based digital predistortion structure to produce an adjusted pre-distorted transmit signal to correct one or more non-linearities in the power amplifier operable coupled to the digital predistortion module; and
generate an output signal using the power amplifier based on the adjusted pre-distorted transmit signal.

9. The electronic device of claim 8, wherein the GMP model is configured to linearize one or more intra-level non-linearities.

10. The electronic device of claim 8, wherein the GMP model comprises multiple GMP sub-models, wherein each of the multiple GMP sub-models are based on one of multiple supply voltage levels of the DET system.

11. The electronic device of claim 10, wherein the processor, while causing the electronic device to process the pre-distorted transmit signal using the AI model, is further configured to cause the electronic device to:
input the measurement of the digital envelope and the transmit signal into the AI model to produce a residual error estimate signal; and
adjust the pre-distorted transmit signal using the residual error estimate signal.

12. The electronic device of claim 11, wherein the AI model is configured to linearize residual non-linearities caused by inter-level transitions between the multiple supply voltage levels.

13. The electronic device of claim 11, wherein the processor, while causing the electronic device to adjust the pre-distorted transmit signal using the residual error estimate signal, is further configured to cause the electronic device to subtract the residual error estimate signal from the pre-distorted transmit signal.

14. The electronic device of claim 8, wherein the processor, while causing the electronic device to process the pre-distorted transmit signal using the AI model, is further configured to cause the electronic device to:
input the pre-distorted transmit signal and the measurement of the digital envelope into the AI model to generate an adjusted pre-distorted transmit signal.

15. A non-transitory computer-readable medium comprising program code, that when executed by at least one processor of an electronic device, causes the electronic device to:
receive a measurement of a digital envelope at a digital predistortion module having an artificial intelligence (AI)-based digital predistortion structure for a digital envelope tracking (DET) system;
receive a transmit signal at the digital predistortion module;
input the measurement of the digital envelope and the transmit signal into a generalized memory polynomial (GMP) model of the AI-based digital predistortion structure to produce a pre-distorted transmit signal;
process the pre-distorted transmit signal using an AI model of the AI-based digital predistortion structure to produce an adjusted pre-distorted transmit signal to correct one or more non-linearities in a power amplifier operable coupled to the digital predistortion module; and
generate an output signal using the power amplifier based on the adjusted pre-distorted transmit signal.

16. The non-transitory computer-readable medium of claim 15, wherein the GMP model is configured to linearize one or more intra-level non-linearities.

17. The non-transitory computer-readable medium of claim 15, wherein the GMP model comprises multiple GMP sub-models, wherein each of the multiple GMP sub-models are based on one of multiple supply voltage levels of the DET system.

18. The non-transitory computer-readable medium of claim 17, wherein the program code, that when executed by the at least one processor of the electronic device, causes the electronic device to process the pre-distorted transmit signal using the AI model, further comprises program code, that when executed by the at least one processor of the electronic device, causes the electronic device to:
input the measurement of the digital envelope and the transmit signal into the AI model to produce a residual error estimate signal; and
adjust the pre-distorted transmit signal using the residual error estimate signal.

19. The non-transitory computer-readable medium of claim 18, wherein the program code, that when executed by the at least one processor of the electronic device, causes the electronic device to adjust the pre-distorted transmit signal using the residual error estimate signal, further comprises program code, that when executed by the at least one processor of the electronic device, causes the electronic device to subtract the residual error estimate signal from the pre-distorted transmit signal.

20. The non-transitory computer-readable medium of claim 15, wherein the program code, that when executed by the at least one processor of the electronic device, causes the electronic device to process the pre-distorted transmit signal using the AI model, further comprises program code, that when executed by the at least one processor of the electronic device, causes the electronic device to:
input the pre-distorted transmit signal and the measurement of the digital envelope into the AI model to generate an adjusted pre-distorted transmit signal.
